(19) United States
(12) Patent Application Publication
(10) Pub. No.: US 2005/0193931 A1
(43) Pub. Date: Sep. 8, 2005

(54) Security lockboxes -- several designs, two materials, two locks, and two brackets

(76) Inventor: Edie M. Boudreau, Eureka, NV (US)

Correspondence Address: Ms. Edie Boudreau, 31 Adams Street, P.O. Box 594, Eureka, NV, 89316-0594, US

(21) Appl. No.: 10/818,217

(22) Filed: Apr. 1, 2004

Related U.S. Application Data
(60) Provisional application No. 60/459,498, filed on Apr. 1, 2003.

(51) Int. Cl. E05G 1/00

(52) U.S. Cl. 109/50

(57) ABSTRACT

My invention is several models of security lockboxes that provide protection against children's access to dangerous contents of each lockbox. In order to offer a wide variety of prices for people of all incomes, these lockboxes have multiple designs, sizes, locks and fabrication materials, each of which provides secure containment of the items when locked onto its bracket. All of these lockboxes have the same innovative design, which is an open or partially open back to insert/remove the contents. The wall to which the bracket is attached is the back of the lockbox when it is locked to its bracket. The open backs of all models provide easy access to the contents for adults who have the keys or combinations to release the lockbox from its bracket. Various sizes of two models are made of powder-painted steel, and a third is molded polyethylene.

My invention and its dependent inventions are several models of security lockboxes that provide protection against children's access to dangerous contents of each lockbox. In order to offer a wide variety of prices for people of all incomes, these lockboxes have multiple designs, sizes, locks, and fabrication materials, each of which provides secure containment of the items when locked onto its bracket.

All of these lockboxes have the same innovative design, which is an open or partially open back to insert/remove the contents. The wall to which the bracket is attached is the back of the lockbox when locked to its bracket. The open backs of all models provide easy access to the contents for adults who have the keys or combinations to release the lockbox from its bracket. The lockboxes can contain guns, ammunition, toxic-cleaning supplies, poisons or medications. Other items could include valuables or documents. Various sizes of two models are made of powder-painted steel, and a third is molded polyethylene.

One type of polished steel security bracket for the steel lockboxes is bent into an L-shape. The short length of the “L” extrudes forward at the top end of the bracket, to be inserted through the open back of the lockbox into a mounting bracket holder which is welded to the inside of the top of the lockbox. The long length of the “L” bracket contains several bolt holes and is bolted (pointing downward) to a stud of a wall or a solid door. The brackets come in several sizes to go with several designs of lockboxes—slim-line, rectangular, or the molded polyethylene top container.

During remodeling or construction of a home or business, the brackets can also be mounted in the same position inside of a wall directly to the stud, where the lockbox will be partially extending only an inch or two from the finished wall in order provide a purchase for the adults' fingers to pull the lockbox off the bracket when it is unlocked.

A second type of bracket is one that fits over exterior doors. These brackets can be placed to open inside locked doors for people to access dangerous materials inside their garages, or they can be placed to open on the outside of doors to provide pickup or delivery service for people who have the key or combination to their locks. These brackets also come in sizes to correspond to its matching lockbox.

When any bracket is inserted into the back of its corresponding lockbox, the front edge will extend through the front opening above the lock. The openings on both the top of the steel lockbox and the bracket are designed to be above each other, so that the lock's cam or tubular hold can rise through both of them and thus lock them together. Either way, the lockbox contents are inaccessible to children or anyone without a key or combination, depending upon the lock.

All the lockboxes are attractive enough to be mounted on bathroom, laundry room, or kitchen walls, as well as in garages. They are also small enough to be mounted behind beds, bedside tables, or in closets or cupboards. The slim-line steel model with a combination lock can also be mounted to the underside of a bed frame if the bed is set high enough for the adult to set the lockbox free from its bracket by pressing his/her own combination of pushbuttons. The adult will thus be able to access a gun in case of a burglary or other threat.

Additionally, the lockboxes could be used for business purposes when items such as documents, videos, DVDs, rolls of film, or medical specimens, etc.) are to be picked up and/or delivered, using a security bracket that has been bolted onto the solid exterior door or wall, or a door bracket which fits on top of a locked door.

Steel Lockbox Models A, B, C and D

These steel lockboxes have two designs that can be made in various sizes. The lockboxes shown in the drawings—Models A and C—are slim-line designs, and Models B and D are rectangular designs. They are the smallest sizes and the only lockboxes currently in production. All models have their own security brackets and door brackets, as well as a choice of two types of locks (cam key or combination-pushbutton). Models A and B are designed for the cam key locks, and Models C and D are designed for the combination-pushbutton locks. The two types of security brackets are the L-shaped ones that bolt to wall studs or solid doors, and door brackets that fit over doors that are locked for security.

The lockboxes are constructed of 20 gauge (0.036-inch-thick) galvanized steel, which is cut to the shape required for the particular design. Three various-sized openings are cut into the front and top of the design to accommodate the appropriate lock and/or bracket, and three small openings are cut into the short back area of the lockbox to hold rubber grommets to protect walls and doors.

The cut steel is bent to the desired shape and welded at the seams. The current product shown on the specifications have 0.5-inch flanges that are bent and then spot-welded to the inside of the top, sides and back of the lockbox. A similar version of all the steel models have small tabs that are bent in the same way, but the seams are completely welded and present a seamless appearance once they are powder-painted. A galvanized steel “bracket-mount” is bent per specification and then spot-welded inside the top of each lockbox for the steel bracket to slide through from the back to the front of it. The lockbox is then powder-painted both inside and outside for protection. The locks and rubber grommets are added after painting the lockbox.

Various Brackets

The brackets used for all six models of the lockboxes are constructed of 14 gauge (0.75-inch-thick) galvanized polished steel. The dimensions of the security brackets for the steel lockboxes are included with the description and dimensions of each model. The dimensions of the smallest steel models are included in the drawings.

The only differences in both the slim-line and rectangular models are the types and placement of the holes cut for the type of locks each use (key cam or combination-pushbutton). However, complete drawings of all four of the steel models are included: Model A—the slim-line lockbox with the key lock, Model B—the rectangular lockbox with the key lock, Model C—the slim-line lockbox with the combination-pushbutton lock, and Model D—the rectangular model with the combination-pushbutton lock.

The bracket drawings include both the wall security and door designs for the models. All of the bracket specifications (cam key brackets Models G, H, J, and K) are shown in full, and only partial views are included to show the change in lock cut placement for the combination-pushbutton brackets (Models M, N, P and Q). They are included on the same pages as the four cam key brackets. The outside dimensions and bends are the same as the cam key brackets.

Various Locks

The combination-pushbutton lock for the steel lockboxes is the most expensive, and is currently a “Simplex” 9600 series tubular-hold, top-throw gold lock, mounted without the black frame that is included in the sale through our current provider. The same lock without the frame may become available to us for a lower price later. The lockbox bracket slides through the inside bracket mount from the back of the lockbox and extends out through the front slot, and when the lock is locked, its tubular throw comes up through the slot in the bracket and the corresponding slot in the top of the lockbox. The face plate for this lock attaches to the mechanism of the lock with four screws inside of the front of the lockbox.

The cam key lock for the steel lockbox costs 80 percent less than the combination-pushbutton lock. When locked, it has a cam that comes straight up through the cylinder housing, then through the slot in the bracket and the slot in the top of the lockbox.

Both the combination-pushbutton and cam locks are mounted on the front of the steel models of the lockboxes, with a slot above it for the bracket to slide through and a slot on top of the lockbox for the key lock's cam or the combination lock's tubular hold to lock the bracket to the lockbox.

The inexpensive cam key lock for the polyethylene lockbox is a tubular lock such as the “Chicago ACE II” lock, with a round, slotted key instead of a typical key. A “lip” in the cylinder housing slides up inside the bracket connection when it is locked. A second lock that can and may be offered is made of molded rubber by the manufacturer of the lockbox and is designed to have one of multiple key slots, with its special key provided by the manufacturer.

Models A and C Steel Lockboxes

Both the Model A “slim-line” cam key lockbox and the Model C “slim-line combination-pushbutton lockbox shown in the drawings are 9-⅞-inches wide by 9-⅜-inches high by 2-½-inches deep (from front to back), though one or more of these sizes can be modified for certain uses. A 2-¼-inch-long by 3-¾-inch-wide galvanized steel bracket mount is bent as shown and spot welded inside the top at the middle of the lockbox, starting at the back and ending just before the slot for Model A's cam lock opening. The cam-opening slot on top of the lockbox is centered ⅝-inch from the front of the lockbox and is 15/16-inch-long by 3/16-inch-wide. A slot for the bracket to go through is on the middle-front of the lockbox at the very top, just before the bend. That slot is 2-½-inches long and ⅜-inch-wide.

The slim-line security bracket is 2-¼-inches wide. Its length is 2-¾-inches to the L-shaped downward bend, then bends down 6-¾-inches to its slightly rounded end. The top part of the bracket has a 1-½-inch-long by ⅜-inch-wide slot cut 11/16-inch from its square end for a key lock's cam, or ⅜-in. from its square end for a combination-pushbutton lock's cam to go through before going through the slot on the lockbox. The downward part of the bracket has five 3/16-inch-diameter holes for bolts to go through, starting 1-½-inches from the bend and then spaced 1-¼-inches apart.

The slim-line door bracket is also 2-14-inches wide. Its cut length is 8-⅝-inches, and the top part of the bracket that slides through the bracket holder is 2-¾-inches long. There are four bends to a door bracket—to go up, over, and down the inside of the door, with a slight bend at the end. This holds the lockbox tightly to the door, which—when locked—provides a secure back to the lockbox.

All the slim-line lockboxes also include a 1/32-inch-thick hard plastic sheet to hold contents upright. The plastic sheet is 8- 1/32-inches-high by 8- 1/32-inches wide, and is placed inside the lockbox to hold the contents secure before locking it to the bracket.

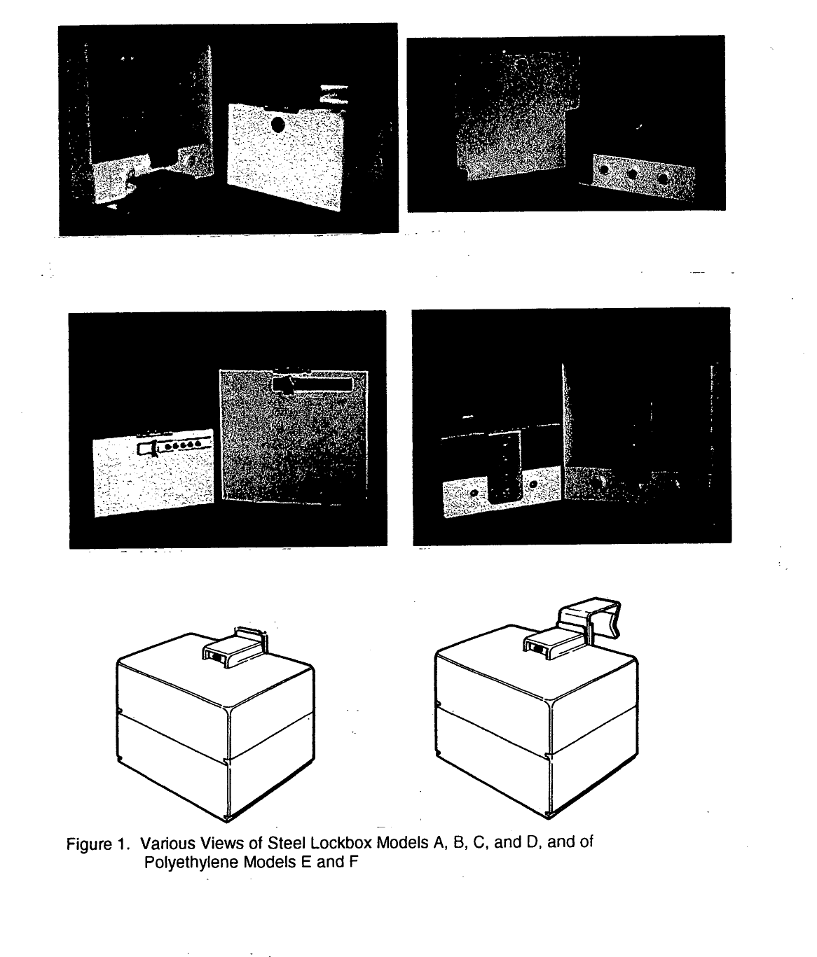

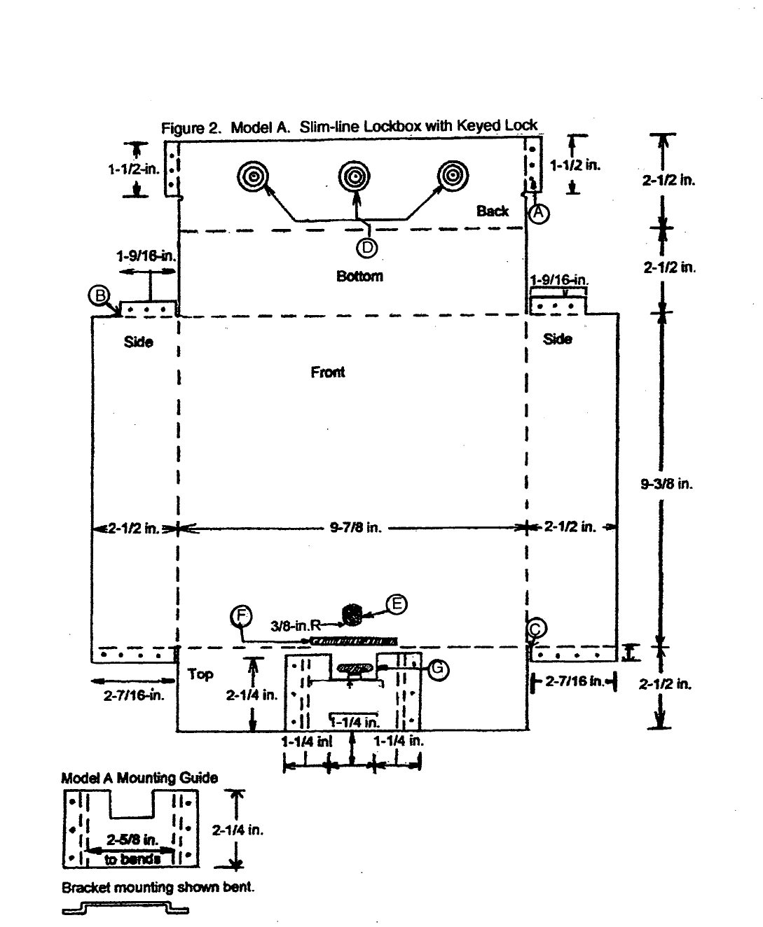

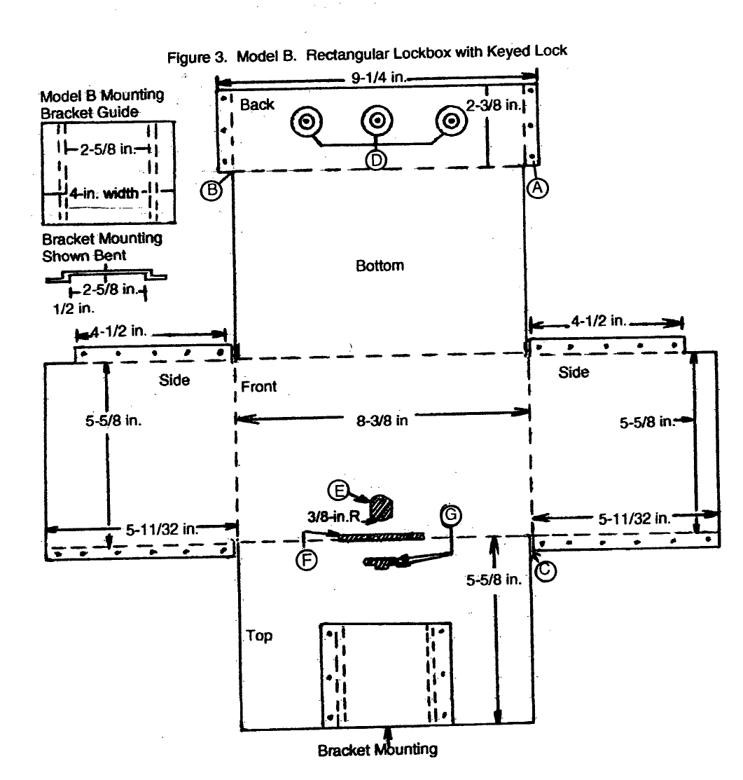

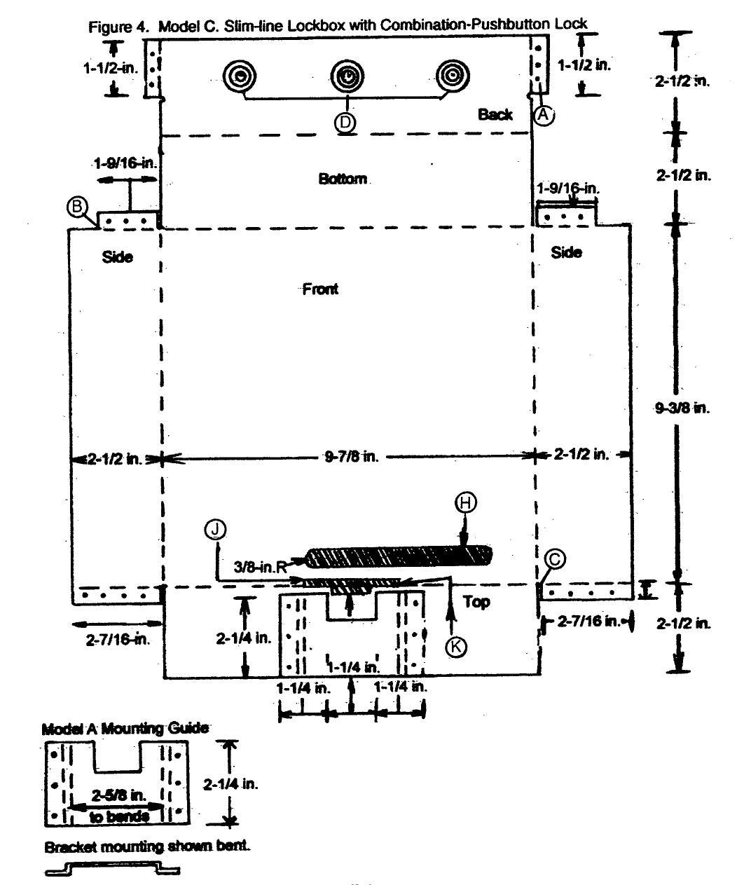

The only difference in the Model C lockbox is that the cuts for the combination-pushbutton lock are different than the size and placement of the lock cuts on Model A. In addition, the cuts for the combination cam are different than those on Model A because that model has a cam key lock. The cuts for the cam and for the bracket opening meet at the bend between the top and the front of the Model C lockbox. The FIG. 4 specification for Model C shows these differences.

Model B and D Steel Lockboxes

The Model B and Model D “rectangular” lockbox sizes are 8-⅜-inches-wide by 5-⅜-inches-high by 5- 11/32-inches deep (from front to back), though these sizes can also be modified if necessary for certain uses. A 3-inch-long by 4-inch-wide galvanized steel mounting bracket holder is bent and spot welded inside the top at the middle of the box, starting at the back and ending before the slot for the cam lock opening. The cam-slot opening on top of Model B lockbox is placed 11/16-inch from the front of the lockbox and is 15/16-inch-long by 3/16-inch-wide. A slot for the bracket to go through is on the middle-front of the lockbox at the very top, just before the bend. That slot is 2-½-inches long and ⅛-inch wide.

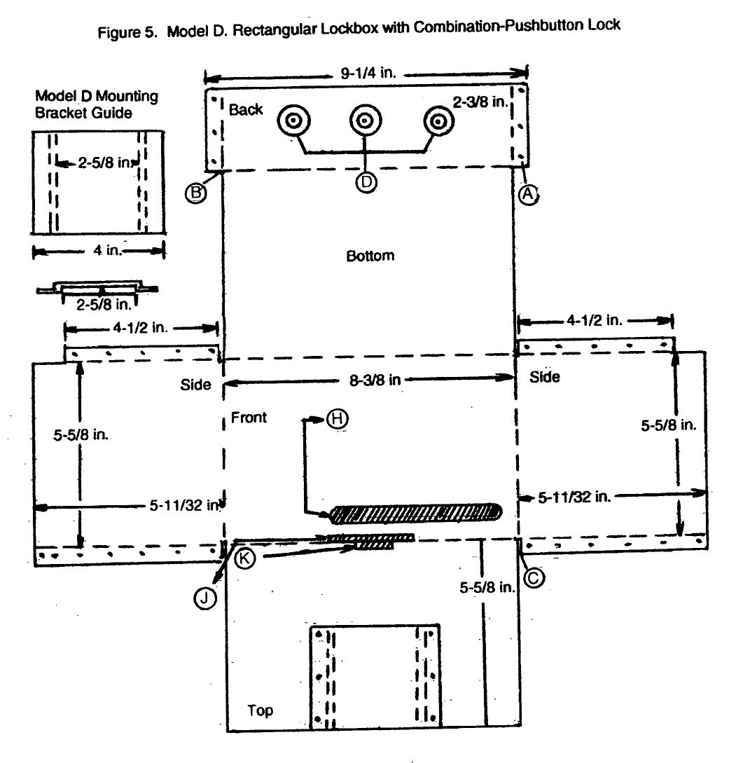

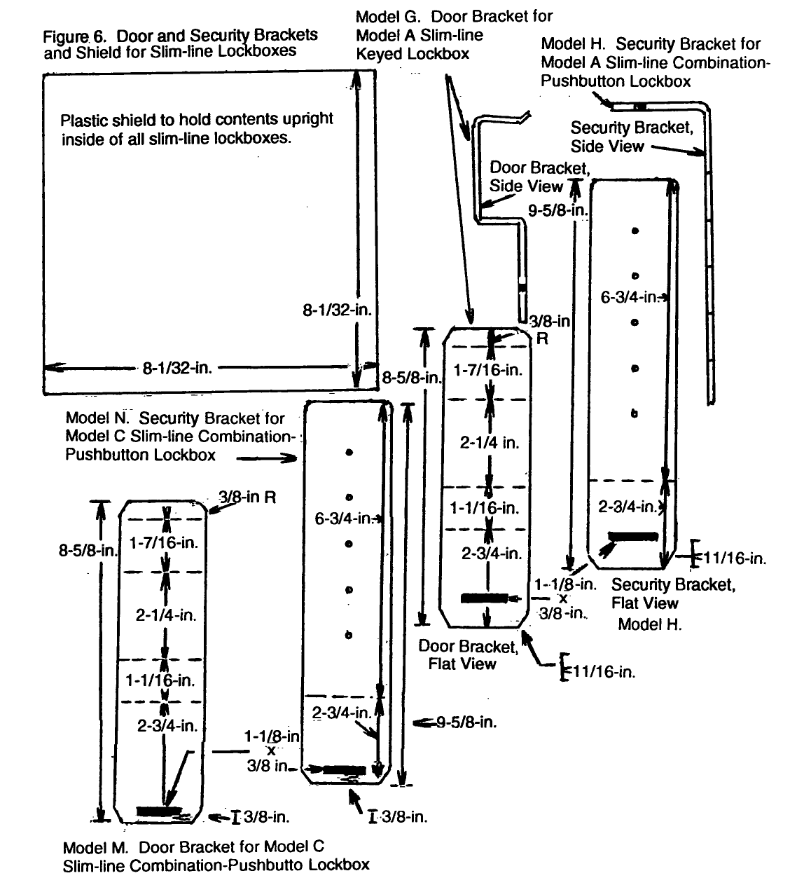

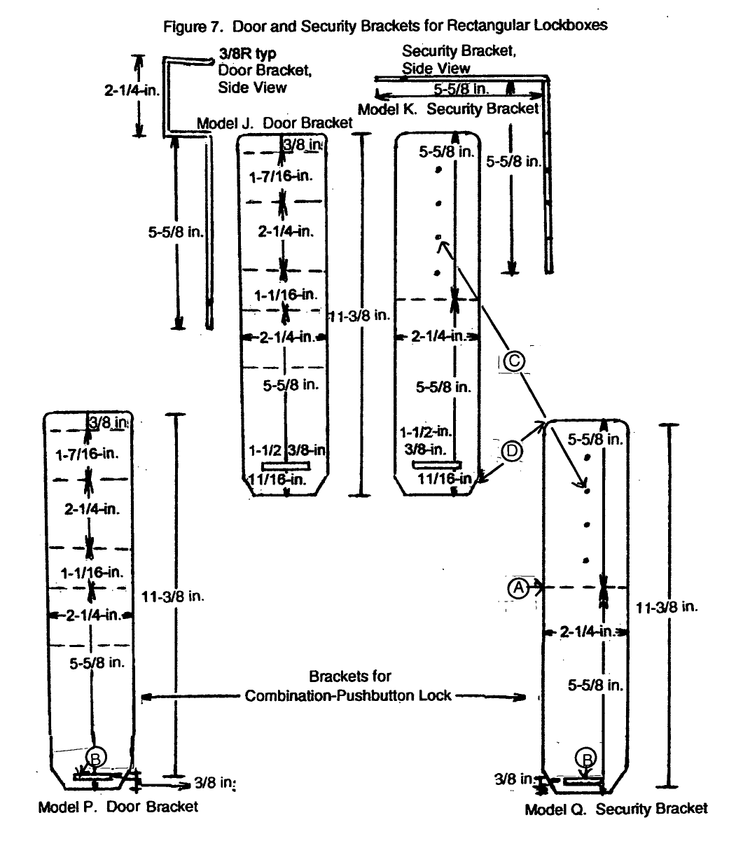

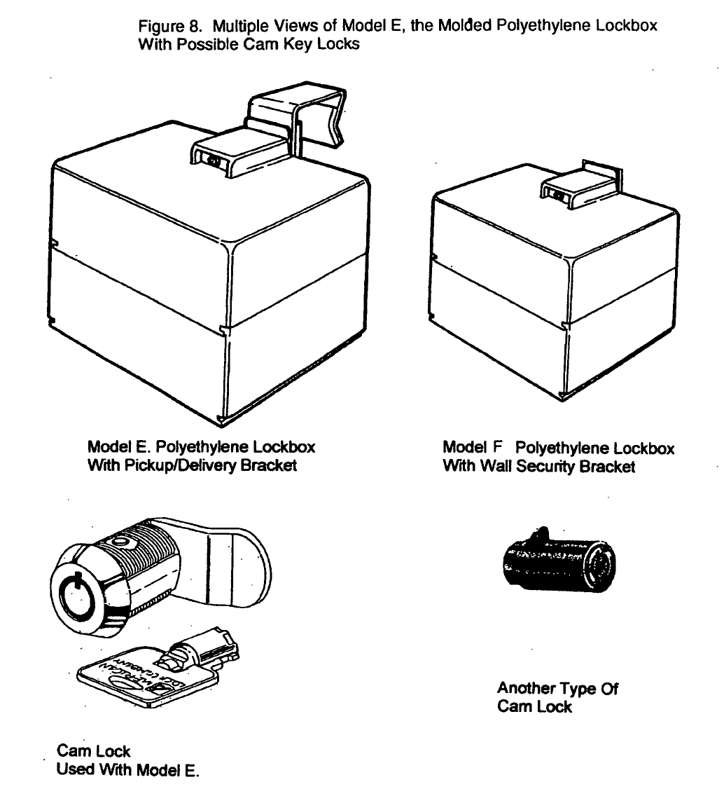

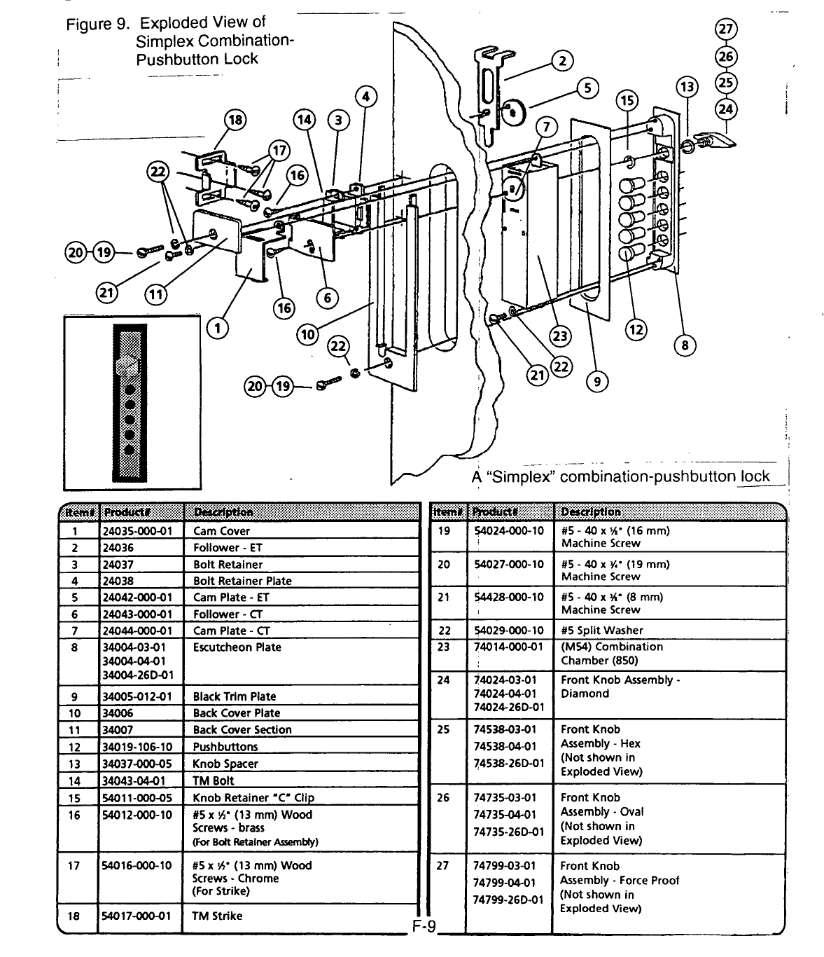

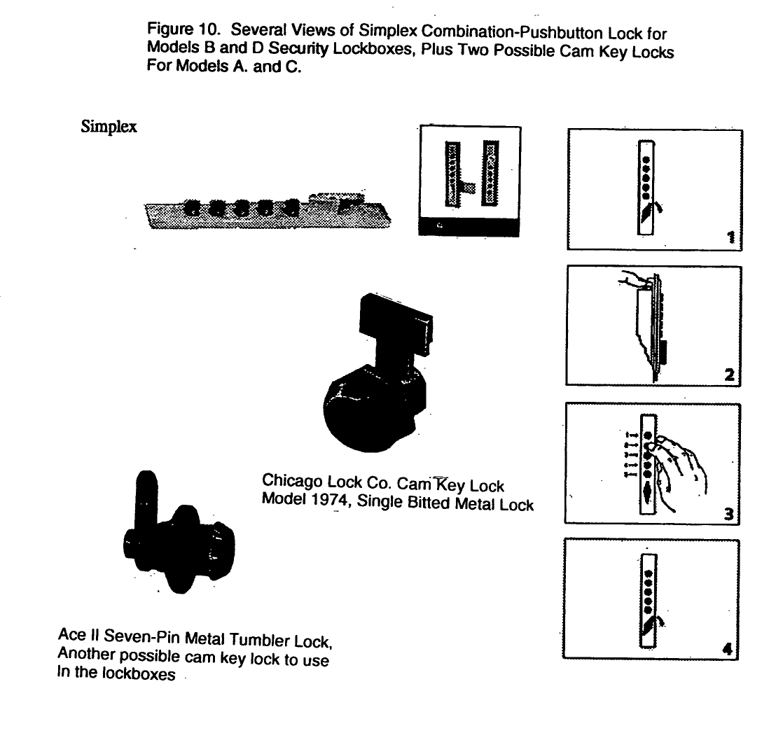

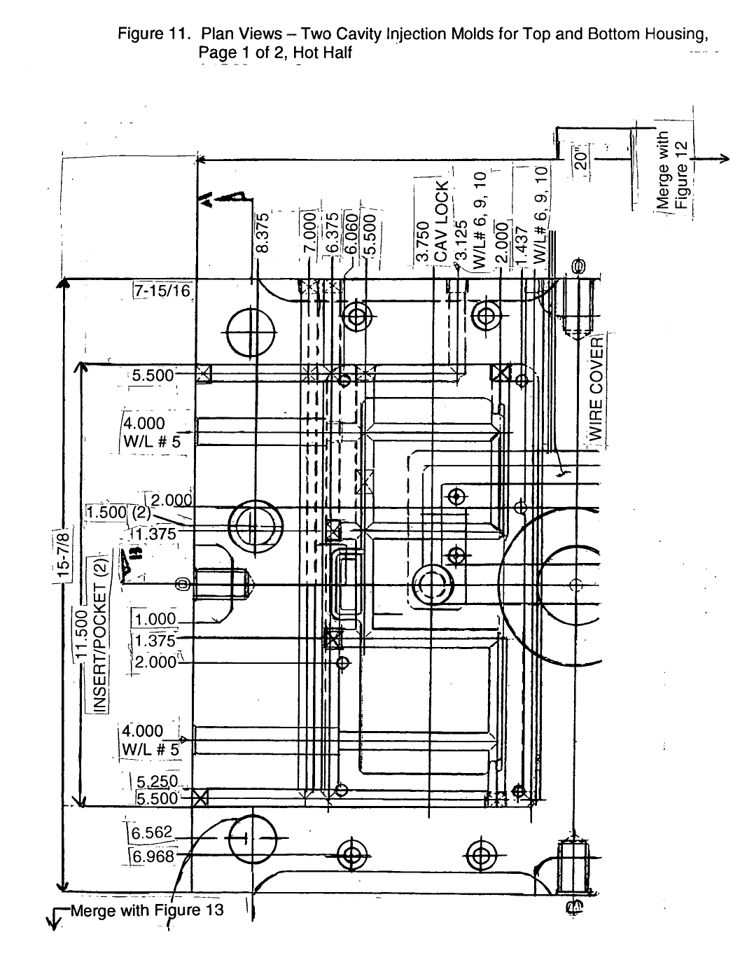

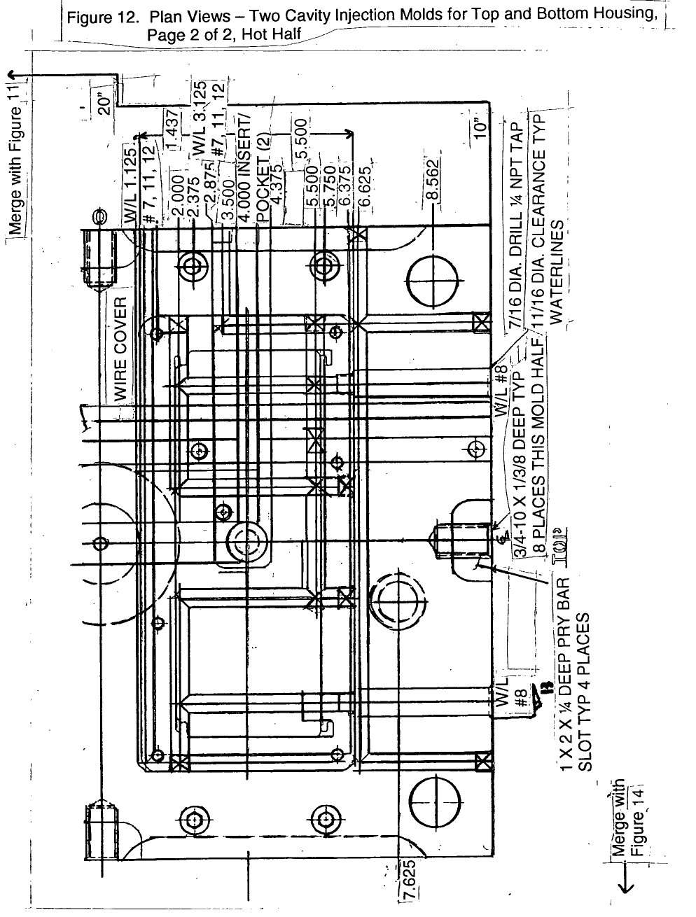

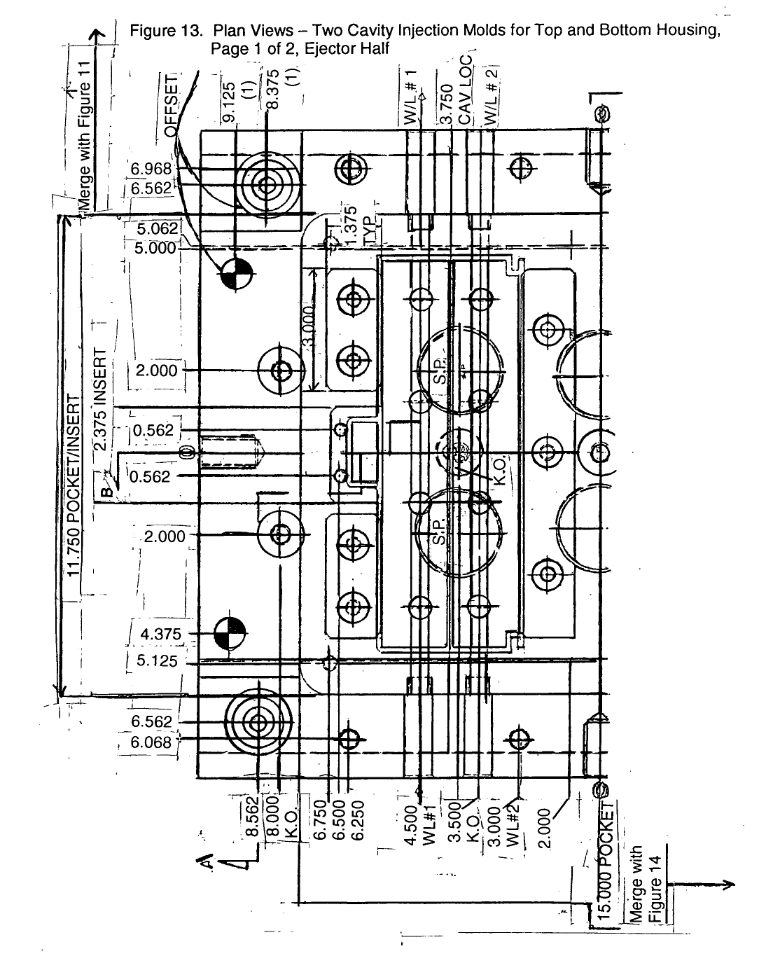

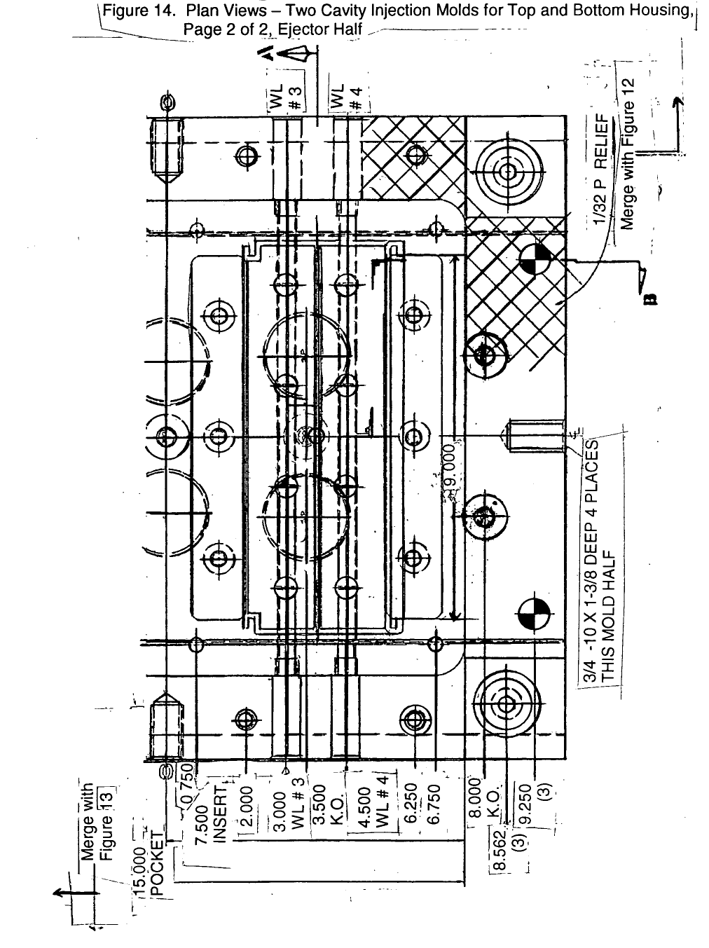

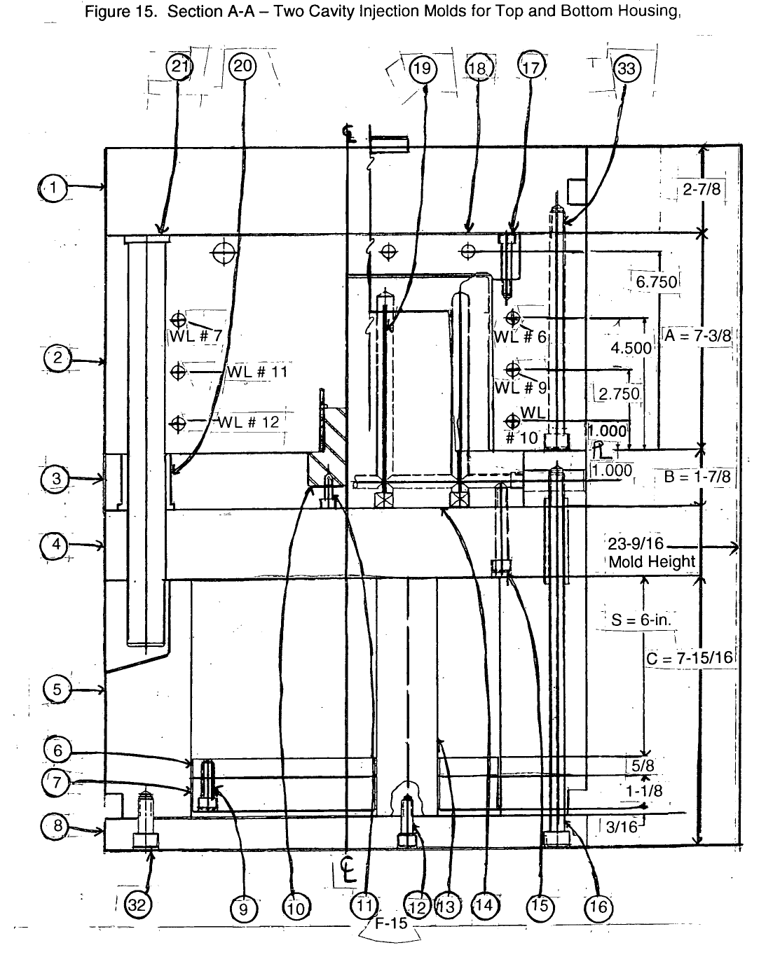

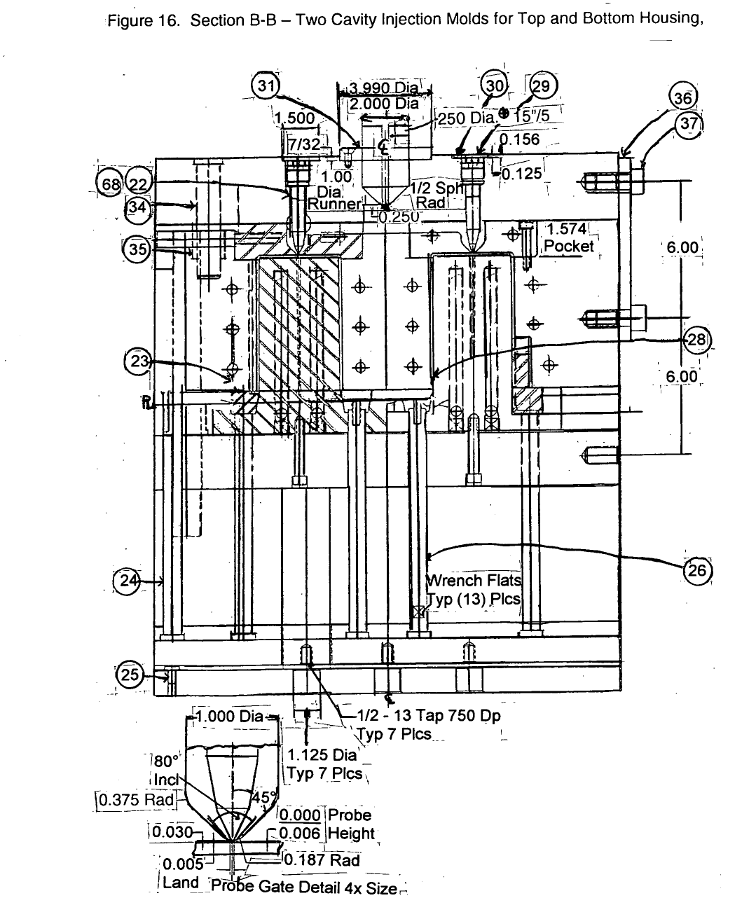

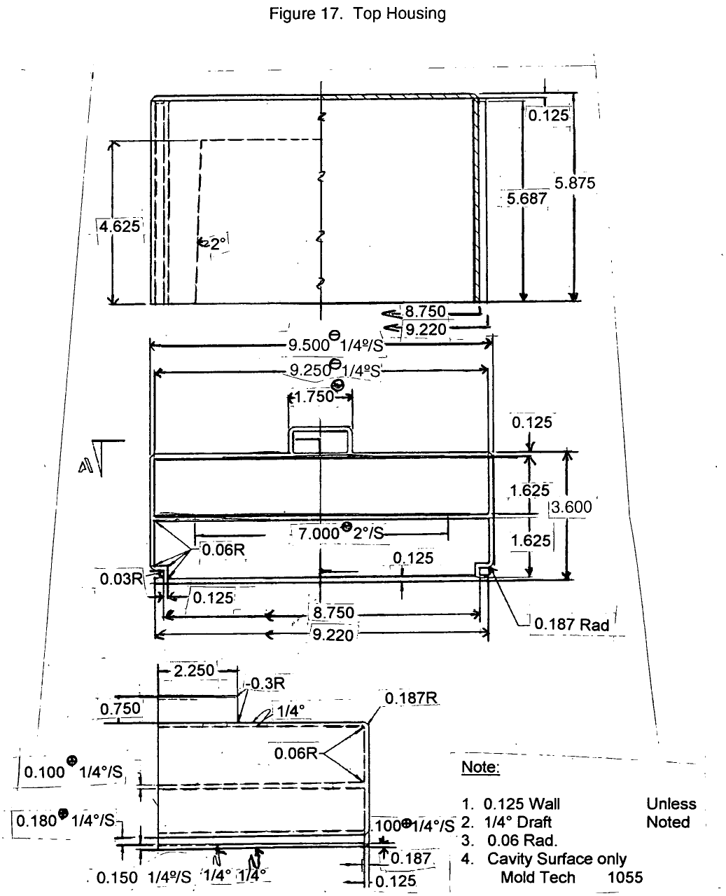

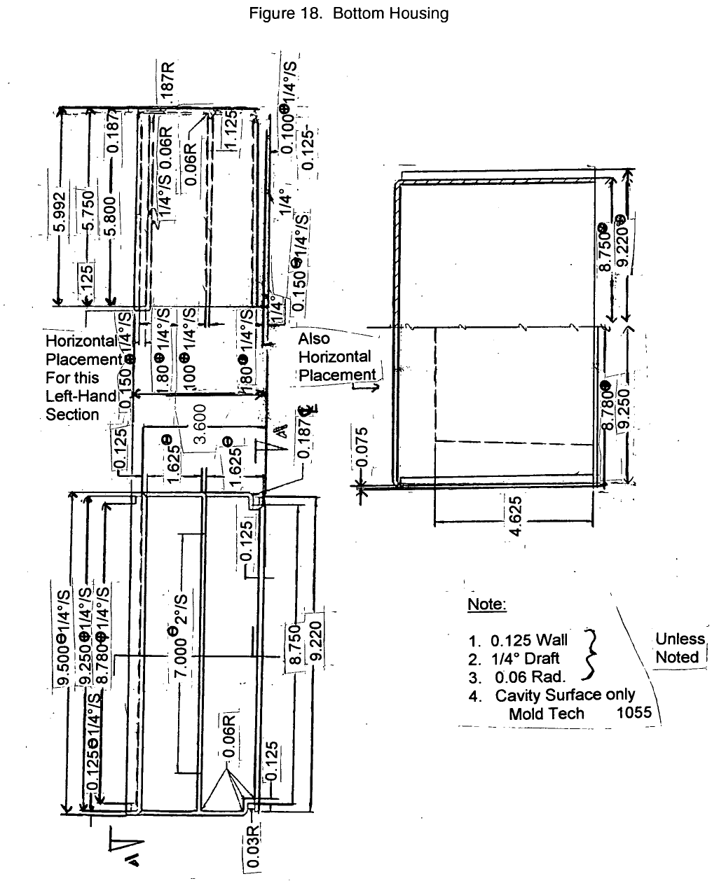

Again, the only difference between Model B and Model D lockboxes is that the cuts for the combination-pushbutton lock are different than the size and placement of the lock cuts on Model B, because that model has a cam key lock. The cuts for the cam and for the bracket opening meet at the bend between the top and the front of the Model D lockbox. The FIG. 5 specification for Model D shows these differences.

The security wall bracket and the door bracket for the rectangular lockbox are 2- 1/4 inches wide and 11-⅜-inches long. The security bracket length is 5-⅝-inches to the L-shaped downward bend, then bends down 5-⅝-inches to its slightly rounded end. The top part of the bracket has a 1-¼-inch-long by ⅜-inch-wide slot cut 11/16-inch from its square end for a key lock's cam, or ⅜-in. from its square end for a combination-pushbutton lock's cam to go through before going through the slot on the lockbox. The downward part of the security wall bracket has five 3/16-inch-diameter holes for bolts to go through, starting 1-½-inches from the bend and then spaced 1-¼-inches apart. The top part of the bracket that slides through the bracket holder is 5-⅝-inches long. There are four bends to the door bracket—to go up, over, and down the inside of the door, with a slight bend at the end. This holds the lockbox tightly to the door, which—when locked—provides a secure back to the lockbox.

TABLE 1
NOTES FOR MODEL E. TWO-CAVITY INJECTION MOLD FOR
TOP AND BOTTOM HOUSING - PAGE 1 OF 4

| | | | | | SP. |
|---|---|---|---|---|---|
| DET. | DESC. | FINISHED SIZE | MATERIAL | AMT. | NOTES |
| 1 | CLAMP PLT | 2⅞ × 15⅞ × 20 | 1030 | 1 | |
| 2 | “A” PLATE | 7⅜ × 15⅞ × 20 | P-20 | 1 | |
| 3 | “B” PLATE | 1⅞ × 15⅞ × 20 | 4130 | 1 | |
| 4 | SUP PLATE | 2⅜ × 15⅞ × 20 | 1030 | 1 | |
| 5 | RAILS | 2⅞ × 7 15/16 × 20 | 1030 | 2 | |
| 6 | PIN PLATE | ⅝ × 10 × 20 | 1030 | 1 | |
| 7 | EJ. PLATE | 1⅛ × 10 × 20 | 1030 | 1 | |
| 8 | CLAMP PLATE | 1⅛ × 15⅞ × 20 | 1030 | 1 | |
| 9 | S.H.C.S. | 5/16-18 × 1¼ [symbol] | STD | 10 | |
| 10 | CORE INSERT | 2⅛ × 2⅜ × 2⅝ | P-20 | 1 | B-I |
| 11 | S.H.C.S. | ¼-20 × ¾ [symbol] | STD | 2 | |
| 12 | S.H.C.S. | ⅜-16 × 1¼ [symbol] | STD | 6 | |
| 13 | SUP. PILLAR | 2-IN. DIA × 8-IN. [symbol] | 1020 | 6 | |
| 14 | CORE INSERT | 7½ × 7¾ × 11 | P-20 | 2 | B-I |
| 15 | S.H.C.S. | ⅜-16 × 2½ [symbol] | STD | 10 | |
| 16 | S.H.C.S. | ½-13 × 12 IN. [symbol] | STD | 8 | |
| 17 | S.H.C.S. | 5/16-18 × 1¾ [symbol] | STD | 12 | |
| 18 | CAV INSERT | 1.574 × 5½ × 11½ | P-20 | 2 | B-I |
| 19 | BAFFLE | 3/32 × 9/16 × 12 [symbol] | BB-40-12 | 16 | DME |
| 20 | BUSHING | 1¼ I.D. × 1⅞ | 5752 | 4 | DME |
| 21 | LEADER PIN | 1¼ DIA. × 13¾ [symbol] | 5322-GL | 4 | DME |
| 22 | PROBE | 0.625 DIA. × 2.893 [symbol] | AFPN-310 | 2 | DME |
| 23 | LIFTER | 1 × 1⅜ × 9 [symbol] | H-13 | 3 | G |
| 24 | RETURN PIN | ¾ DIA. × M-14 | EX-41 | 4 | DME |
| 25 | STOP PIN | ⅝ H. DIA. × ⅝ [symbol] | 7100 | 12 | DME |
| 26 | LIFTER PIN | ¾ DIA. × M-10 | EX-41 | 13 | DME |
| 27 | LIFTER | 1 × 1⅜ × 3 [symbol] | H-13 | 2 | G |
| 28 | SET SCREW | ⅜-16 × 1⅛ [symbol] | STD | 13 | |
| 29 | WIRE COVER | ⅛ × 1½ × 8⅝ | FLT GRND STK | 2 | |
| 30 | F.H.S. | #10-32 × ⅜ [symbol] | STD | 4 | |
| 31 | LOC RING | 3.990 DIA. × 17/32 | 6501 | 1 | DME |
| 32 | S.H.C.S | ½-13 × 1½ | STD | 4 | |
| 33 | S.H.C.S. | ½-13 × 7½ | STD | 8 | |
| 34 | GUIDE PIN | 1-IN. DIA. × 5¼ [symbol] | 5205-GL | 2 | DME |
| 35 | BUSHING | 1-IN. DIA. × 1⅜ [symbol] | 5503 | 2 | DME |
| 36 | STRAP | ½ × 2 × 8 [symbol] | 1030 | 2 | |
| 37 | S.H.C.S. | ¾-10 × 1½ [symbol] | STD | 4 | |
| 38 | | | | | |
| 39 | | | | | |
| 40 | | | | | |
| 41 | | | | | |

TABLE 1
NOTES FOR MODEL E. TWO-CAVITY INJECTION MOLD FOR
TOP AND BOTTOM HOUSING - PAGE 2 OF 4

| | | FINISHED | | | SP. |
|---|---|---|---|---|---|
| DET. | DESC. | SIZE | MATERIAL | AMT. | NOTES |
| 42 | | | | | |
| 43 | | | | | |
| 44 | | | | | |
| 45 | | | | | |
| 46 | | | | | |
| 47 | | | | | |
| 48 | | | | | |
| 49 | | | | | |
| 50 | | | | | |
| 51 | | | | | |
| 52 | | | | | |
| 53 | | | | | |
| 54 | | | | | |
| 55 | | | | | |
| 56 | | | | | |
| 57 | | | | | |
| 58 | | | | | |
| 59 | | | | | |
| 60 | | | | | |
| 61 | | | | | |
| 62 | | | | | |
| 63 | | | | | |
| 64 | | | | | |
| 65 | | | | | |
| 66 | | | | | |
| 67 | | | | | |
| 68 | T/C | ¼ DIA. × 2.740 [symbol] | AFTC-213-2 | 2 | DME |
| | HEATER | | | | |
| 69 | | | | | |
| 70 | | | | | |
| 71 | | | | | |
| 72 | | | | | |
| 73 | | | | | |
| 74 | | | | | |
| 75 | | | | | |
| 76 | | | | | |
| 77 | | | | | |
| 78 | | | | | |
| 79 | | | | | |
| 80 | | | | | |
| 81 | | | | | |

[image]

[image]

1. What I claim as my invention is the creation of several models of security lockboxes to provide protection against children's access to dangerous contents of the lockbox. The unique feature of these lockboxes, which deserves a utility patent, is the open backs of all models, which allows the adult owner to easily insert and remove the contents. The wall or solid door to which its bracket is attached provides the full back of the lockbox when it is locked to its bracket.
The lockboxes can contain dangerous items such as guns, other weapons, ammunition, and/or toxic cleaning supplies, poisons or medications. Other items could include jewelry, cash, valuables, or documents. The open backs of all models provide easy access to the contents for adults who have the keys or combinations to release the lockbox from its bracket.
In order to offer a wide variety of prices to serve disadvantaged people, as well as those who are financially secure, these lockboxes have multiple designs, sizes, locks, and fabrication materials; each of which will provide secure containment for many types of dangerous or valuable items when it is locked onto its own security bracket. Various sizes of two models are made of powder-painted steel, and a third model is molded H.D. polyethylene. In addition, both cam key locks and combination-pushbutton locks are offered.
In addition to the wall security bracket that bolts on to the studs of a wall or a solid door, a door bracket is offered that fits over an exterior door. This can provide security to the contents for pickup or delivery purposes for individuals or businesses. The only requirement is that the person picking up or delivering items has a key to a lockbox with a key lock, or the combination of the combination-pushbutton lock.
